(19) United States
(12) Patent Application Publication
(10) Pub. No.: US 2018/0281159 A1
(43) Pub. Date: Oct. 4, 2018

(54) Three jaw adjustable socket ratchet wrench

(71) Applicant: Thomas Carnesi, Torrance, CA (US)

(72) Inventor: Thomas Carnesi, Torrance, CA (US)

(21) Appl. No.: 15/530,955

(22) Filed: Mar. 28, 2017

(51) Int. Cl. B25B 13/44; B25B 13/46; B25B 23/00; B25G 1/04

(52) U.S. Cl. CPC B25B 13/44; B25G 1/043; B25B 23/0028; B25B 13/463

(57) ABSTRACT

A three jaw adjustable socket ratchet wrench apparatus comprised of a permanently attached adjustable socket head assembly having three radially positioned jaws which ride trilaterally within an upper cylindrical housing; the extended wrench embodiment has a flexible ratcheting head and a permanently attached three jaw adjustable socket that swivels angularly from +90 folded to +45 to 180 degrees to −45 degrees back to 180 degrees; the extended swiveled arm female lug end is attached onto the male lug of the ratcheting head which has an and an extending cylindrical, shelled, knurled handle which extends outward in two extended distal lengths which can be locked in any of those three positions with the aid of a spring induced détente steel ball bearing; the extended swiveled solid arm has a longitudinal horizontal channel where the outer knurled slide handle rides outward from fully retracted to mid extension adjustment to full extension for extra leverage for high torque requirements; the three vertical jaw members of the adjustable socket head end are abutted inward at 15 degrees to the jaws upper housing radial walls of the same angular taper; each of the jaw member have an interior 120 degrees V-notch which becomes a hexagonal configuration when they are trilaterally spaced apart to accept standard hexagonal configured nuts and bolt type fasteners of various; the adjustable socket's head has a lower driver embodiment having a vertical ⅜ square male shaft that protrudes downward and within the internal central and vertical portion of the ratcheting wheels square female slot; the square male shaft has a vertical through vertical hole to accept a vertical male threaded shaft to control the three jaws to be activated during manual rotation in either a clockwise rotation to expand the jaws opening, and counterclockwise rotation cause the jaws to close in a tapered path; the vertical interior shaft has an upper helix pitch thread screw to accept a horizontal threaded disk of the same thread pitch, the horizontal disk nestles within the horizontal and interior slot on each of the three jaws members, the jaws adjustment in ether rotation is influenced by the users rotation of the lower affixed serrated adjusting knob on the exterior bottom end of the ratcheting head, the ratcheting head having a protective cover plate that is located just below the adjustable sockets lower driver embodiment and nestles into the ratcheting head cavity; the internal vertical adjusting threaded shaft is located between the bottom exterior surface of the ratcheting head and between the radially located jaw members of the sockets' upper housing; when the knurled bottom knob, attached to the main vertical jaw adjusting screw, is rotated by the user, in either direction, this rotation activates the radially positioned jaw members to either move upwards or downwards in a 15 tapered degrees path depending on the axial rotation the use user wish to adjust the three jaw members to; the interior of three jaws are configured hexagonally, 120 degrees v-notch, to grasp a an hexagonal fastener to either tighten or loosen upwards or downward depending on the axial rotation of the main vertical bottom knob; the three jaws maneuvering is accomplished by a smaller, upper diameter actuator ring horizontally seated within a lower internal pocket of each jaw member to influence their movement in either an upward or downward and tapered motion; the main vertical thread screw is attached and retained to the bottom of the adjusting knurled knob; the ratcheting head has a ratcheting pawl that swivels to a reverse to forward ratcheting directions, when the user clicks the ratcheting pawls thumb lever to either a forward or a reverse direction this option will either lock the ratcheting head to tighten a selected bolt fastener or loosen a selected bolt size in the pawls opposing direction; the ratcheting wrenches extending arm has three extended positions for a type of torque requirement needed.

### BACKGROUND OF THE INVENTION

This utility patent application is for a three jaw adjustable socket ratchet wrench apparatus having a socket head with three jaws trilaterally spaced 120 degrees that are permanently attached onto a ratcheting wrench mechanism; each jaw has a 120 degrees interior v-notch feature which becomes an hexagonal configuration to accept hexagon type nuts and bolt fasteners of the same configuration; the adjustable socket ratchet wrench apparatus has twelve main components as follows: three jaw members within the upper jaw housing, a lower driver housing affixed onto an internal serrated ratcheting wheel nestled within the cavity of the ratcheting head; a vertical threaded right hand screw which is permanently attached onto the main adjusting serrated adjusting wheel. The serrated wheel is retained internally by a cover plate which is the same profile as the ratcheting head cavity and is retained by an adjustable sockets lower driver unit. A smaller knurled adjusting knob is located at the underside of ratcheting head exterior surface, and is attached onto a threaded main vertical jaws adjusting screw; the thread of the main vertical adjusting screw activates the smaller upper horizontal threaded disk to activate the three jaw members at their lower horizontal keyway slot; the manual rotational activation and influences the three jaw members to move in a 15 degrees inward path to close the jaws to a smaller hex sizes or tapered outward and back to a downward path at a 15 degrees for larger bolt size adjustment. The upper socket housing and lower main driver components have a right hand thread and are secured as a unit by three radial positioned horizontal dowel pins. Each jaw member has an interior 30 degrees dovetail slot on the jaws back surface. This dovetail feature rides and interlocks within the corresponding male dovetail node feature on the interior wall of the sockets upper jaw cylinder for additional jaw stability.

### CLASS 81/177 REFERENCES CITED

### U.S. Patent Documents

| 3,724,299 A | April 1973 | Nelson |
|---|---|---|
| 81/128. | | |
| 4,213,355 A | July 1980 | Colvin |
| 81/128 | | |
| 4,378,714 A | April 1983 | Colvin |
| 81/128 | | |
| 4,663,999 A | May 1987 | Colvin |
| 81/128 | | |
| 5,207,129 A | May1993 | Fossella |
| 81/63.2 | | |
| 5,305,670 A | April 1994 | Fossella et al. |
| 81/63.2 | | |
| 5,448,931 A | September 1995 | Fossella et al. |
| 81/63.2 | | |
| 5,819,607 A | October 1998 | Carnesi |
| 81/128 | | |
| *5,996,446 A | December 1999 | Lee |
| 81/128 | | |
| 6,073,522 A | June 2000 | Carnesi |
| 7,062,996 B2 | June 2006 | Johnson |
| 2006/0086211 A1* | April 2006 | Johnson |
| 7,261,021 A* | August 2007 | Carnesi |
| 1,018,080 | Febuary 1912 | Reston |
| 1,371,350 | March 1921 | Campbell |
| 1,578,065 | March 1926 | Bemus et al. |
| 1,626,906 | May 1927 | Zilliox |
| 1,769,070 | July 1930 | Nowosielski |
| 2,636,411 | April 1953 | Wood |
| 2,757,564 | August 1956 | Reaves |
| 2,897,437 | July 1959 | Briggs et al. |
| 2,982,160 | May 1961 | Little |
| 3,039,340 | June 1962 | Livermont |
| 3,505,714 | April 1970 | Boileau |
| 3,572,188 | March 1971 | Christian, Jr. |
| 4,278,314 | July 1981 | Taub |
| 4,324,158 | April 1982 | Le Roy |
| 4,441,387 | April, 1984 | Hsidericks |
| 4,480,511 | November 1984 | Nickipuck |
| 4,703,636 | November 1987 | Mayer |
| 4,748,874 | June 1988 | Sharp et al. |
| 4,768,405 | September 1988 | Nickipuck |
| 4,825,732 | May 1989 | Arnold |
| 4,905,549 | March 1990 | Nickipuck |
| 4,938,107 | July 1990 | Nickipuck |
| 5,005,448 | April 1991 | Main |
| 5,289,745 | March 1994 | Beardsley |
| 5,291,809 | March 1994 | Fox, III et al. |
| 5,901,620 | May 1999 | Arnold |
| 6,009,777 | January 2000 | Jarvis |
| 6,263,766 | July 2001 | Jarvis |
| 6,516,689 | Febuary 2003 | Bates |

### CROSS-REFERENCE TO RELATED APPLICATIONS

### BACKGROUND OF THE INVENTION

### Field of the Invention

The present invention provides a socket head having a first, second and third jaw member that are radially and triangularly located at the top the embodiment to enables the user to adjust the jaws to a selected size in either metric or inch unit to accommodate hexagonal fasteners of various sizes. The user simply rotates the bottom serrated wheel at the bottom side of the ratcheting head embodiment to rotate in either a clockwise or counterclockwise rotation to adjust the jaw members influence to either a closing or smaller hexagonal opening or expand the jaws to a larger hexagonal size opening depending on the rotational direction the knurled actuator knob is being turned.

### Description of the Prior Art

In U.S. Pat. No. 4,898,052 Decmeber 1999/Lee: there is disclosed an adjustable socket ratchet wrench which is manually adjustable by an internal cable, when the user pushes the lever upwards to expand the two opposing jaws outward to enable the socket to grasp nuts or bolts which are hexagonal configured of different sizes. The two opposing jaw members ride within an internal channel provided internally within the ratcheting head; the jaws are adjustably expanded apart and released to grasp hexagonal bolts of a selected size. Although this particular adjustable socket wrench allows a user to make the necessary adjustments, it includes many parts and has minimal torque strength based on its design and various materials utilized that may add to the cost of making this adjustable socket ratchet wrench.

### SUMMARY OF THE INVENTION

1. The object of this invention is to provide a three jaw adjustable socket ratchet wrench apparatus having a sizeable range from ⅜ to ⅝ inch, and 10 mm to 17 mm to either tighten or loosen hexagonal configured nuts and bolt type fasteners of a certain type. This new preferred three jaw adjustable socket ratchet wrench apparatus has a two-in-one function for tightening and loosening standard hex configured fasteners; this three jaw preferred adjustable socket ratchet wrench apparatus has a range of twelve hexagonal size openings that range as follows: ⅜ inch, 10 mm, 1 mm, 7/16 inch, ½ mm, ½ inch, 13 mm, 14 mm, 9/16 inch, 15 mm, 16 mm, ⅝ inch and 17 mm.

2. The upper three jaw adjustable socket embodiment is merged with that of the lower flexible ratchet wrench embodiment as functional unit. The ratchet wrench embodiment includes a swiveled handle that bends for −90 degrees to −45 degrees to 180 degrees horizontal to +90 degrees to +45 degrees, the solid handle also includes a hollowed slideable handle that extend outward to two distant extension for greater torque capabilities.

### DESCRIPTION OF THE DRAWINGS

For better understanding the present invention and other objects and further features thereof, reference is made to the following description which is to be read and interpreted in conjunction with the accompanying drawings therein:

FIG. 1 is an isometric perspective view of the adjustable socket assembly in an approximately 30 degree view looking downwards at the adjustable socket assembly with arm extended mid-way.

FIG. 2 is an isometric exploded view of the three jaw adjustable socket ratchet wrench assembly in a 30 degree view looking downwards at all the components.

FIG. 3 is a left side view of the adjustable socket ratcheting wrench assembly at mid extension.

FIG. 4 is a cross section hatch view of the adjustable socket ratcheting wrench assembly at mid extension.

FIG. 5 is a top view of the adjustable socket ratcheting wrench assembly at mid extension.

FIG. 6 is a bottom view of the adjustable socket ratcheting wrench assembly at mid extension.

FIG. 7 is a left side profile view of the adjustable socket ratchet wrench profile with flexible handle fully extended and knurled outer extension arm flexed at approximately +45 degrees up.

FIG. 8 is a right side profile view of the adjustable socket ratchet wrench profile with flexible handle midway extended and knurled outer extension arm flexed approximately −45 degrees down.

FIG. 9 is a right side view of the adjustable socket ratchet wrench in midway extended mode and in horizontal 180 degrees position.

FIG. 10 is a left side view of the adjustable socket ratchet wrench folded 90 degrees upward for storage.

FIG. 11 is a side profile view of the adjustable socket head embodiment.

FIG. 12 is a cross section hatch view of the adjustable socket head internal components.

FIG. 13 is a side view of the ratchet wrench sub-assembly with the adjusting knob separated.

FIG. 14 is a bottom view of the ratchet wrench sub-assembly with all components assembled.

FIG. 15 is an Isometric view looking down at approximately 45 deg. of the adjustable socket unit and the ratchet wrench sub-assembly with the adjusting knob separated and retaining dowel pins.

FIG. 16 is a top view of the jaws adjusting disk and adjusting thread and one jaw member at maximum (17 mm) opening.

FIG. 17 is a top view of the adjusting disk and adjusting thread and one jaw member at minimum (⅜) opening.

FIG. 18 is a side view of the main adjusting knob, main vertical adjusting thread and jaw actuator disk with one jaw at maximum opening of (17 mm).

FIG. 19 is a side view of the main adjusting knob, main vertical adjusting thread and jaw actuator disk and bottom exterior adjusting knob with one jaw adjusted at minimum opening of (⅜).

FIG. 20 is a cross section view of (FIG. 19) with the main vertical adjusting thread, jaw actuator disk and bottom exterior adjusting knob with one jaw adjusted at minimum opening of (⅜).

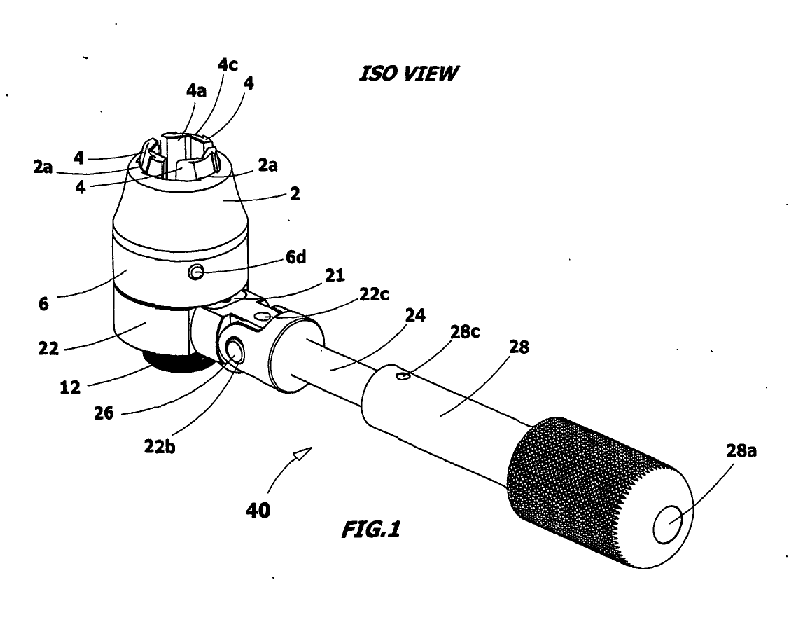

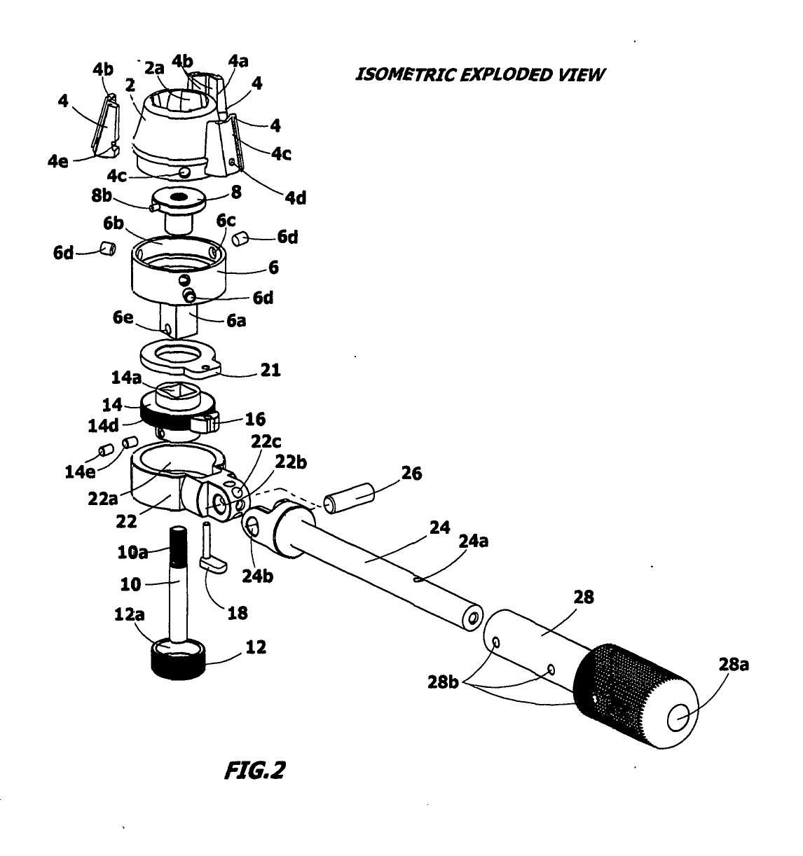

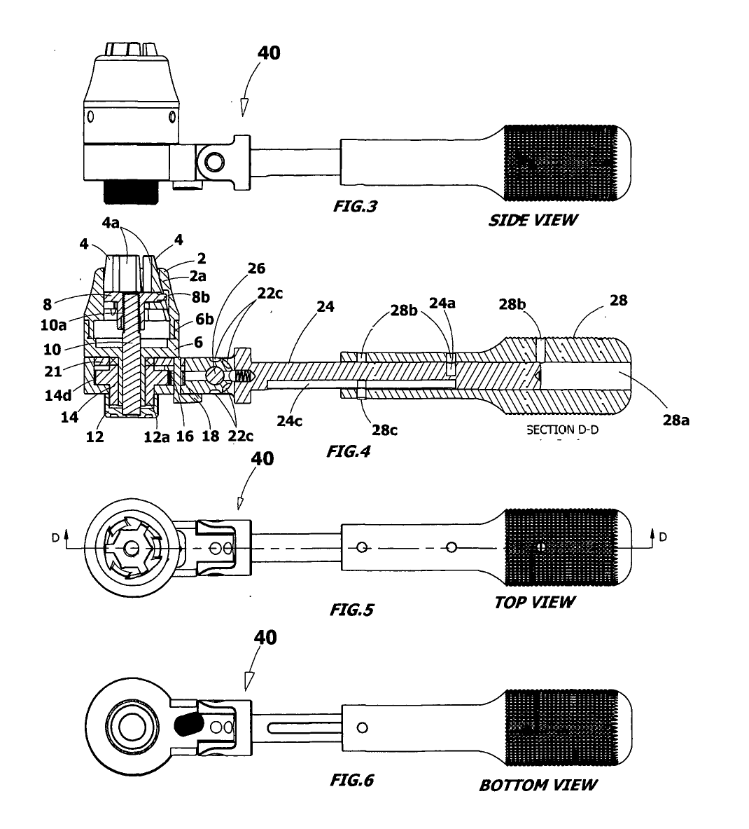

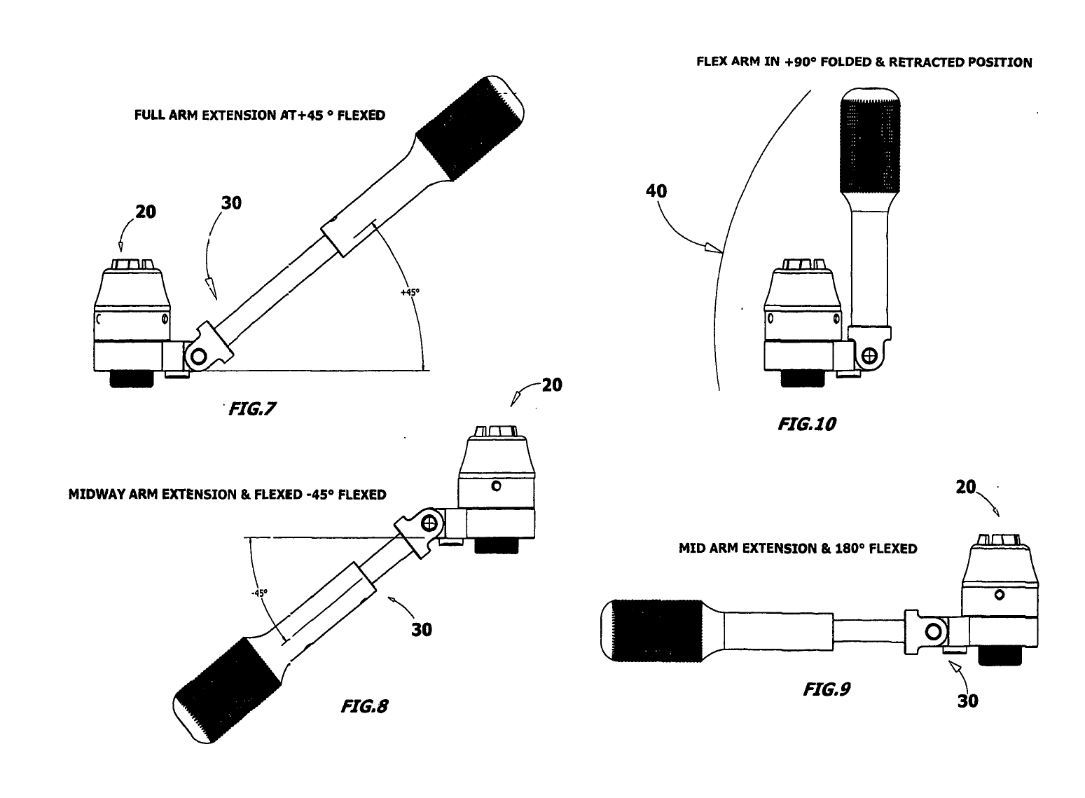

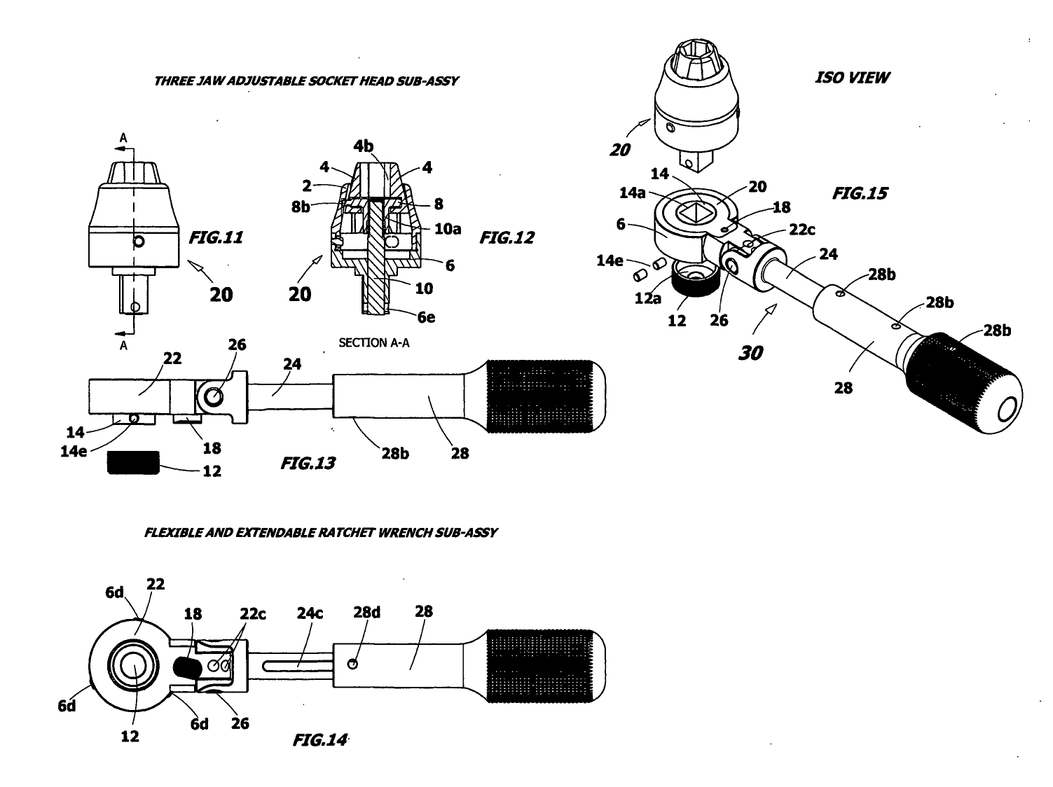

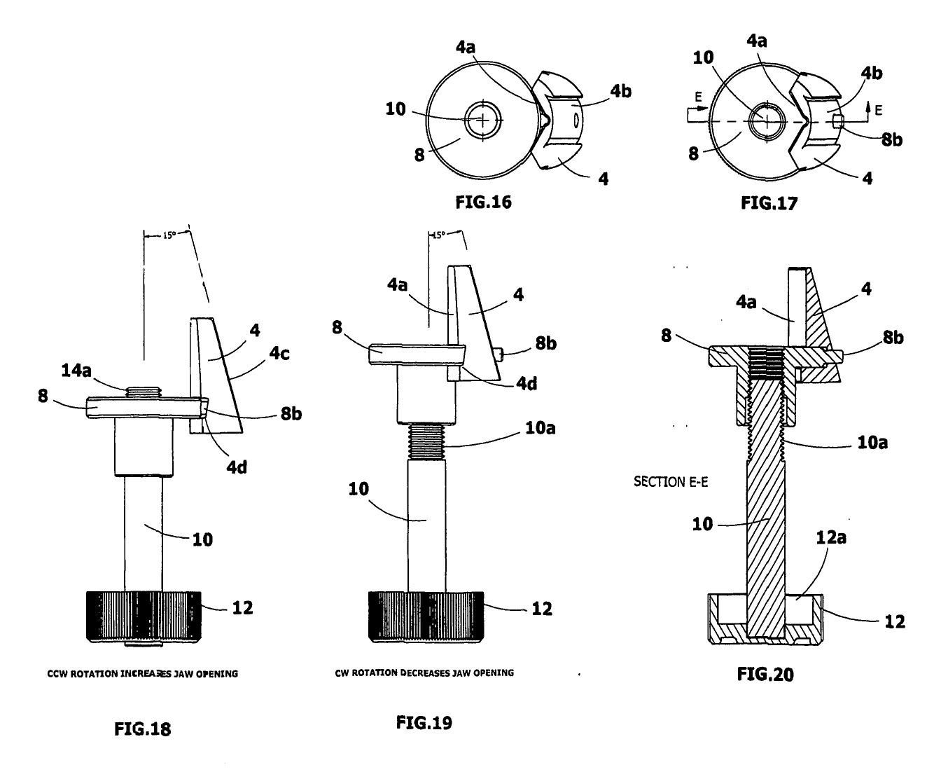

### A DETAILED DESCRIPTION OF THE INVENTION

Referring to Figures, the three jaw adjustable socket ratchet wrench 40 of the present invention comprises an external upper cylindrical adjustable socket driver housing 2 which housed three jaw members which are tri-laterally spaced and tapered 15 degrees inwardly and ride within the configured walls 2a that have a v-notch dovetail node 2b, and centrally positioned to the central axis which accepts three jaw members 4 having an internal 120 degrees v-notch cavity 4a to form a trilateral hexagonal configuration to grasp hexagonal fasteners of various sizes, an external 30 degrees dove tail 4c that rides onto the 30 degrees male node on the interior wall of the upper cylinder, 4a, the adjustable socket embodiment 20 of this invention includes a lower driver embodiment 6, a right hand internally formed thread 6b that mates with the upper cylinder 2 external threaded skirt 2c is firmly retained by three radially located dowel pins 6d; the bottom knurled actuator knob 12 is rotatable about its Z axis that includes a vertical central actuator screw 10; having an upper right hand thread 10a which mates with internal thread of the jaws 4 actuator disks 8 internal thread 8a, the external thread 10a mates with the internal right hand internal thread 8a thread; axial rotation causes the disk 8 which is seated within the jaws internal pocket 4e to activate the three jaw members 4; to move upward on axial clockwise rotation or downward on axial counterclockwise rotation; the jaws 4 move upwards or downwards at a 15 degree taper. The lower socket driver member 6 has ⅜ square vertical shaft 6a to accept the ⅜ square hole of the ratchets central main ratcheting gear 14a to engage the driving ratchet 14 as a unit to rotate either a clockwise, tightening, or reverse, loosening, direction; the ratcheting pawl 16 seats behind the ratcheting gear 14 to escape in either selected tightening or loosening direction within the ratcheting head cavity 22a; when the user selects to tighten or loosen a hex fastener of a certain size, the user clicks the ratcheting pawl lever 18 to either the left or the right position to lock the main ratcheting wheel 14 in those directions to achieve the torque and escape rotation need to either loosen tighten a fastener of a selected size; the bottom knurl adjusting knob 12 located on the bottom exterior side of the ratcheting head 22 to allow a user to rotate in a clockwise or counterclockwise manner to adjusts the socket jaws 4 to a specific hexagonal size; the adjustable socket head assembly 20 is attached onto the central square slot of the main ratcheting gear 14a and is retained by to lower opposing dowel pins 14e, the ratcheting gear 14 and ratcheting pawl 16 is retained by a cover plate 21 that has same peripheral profile as that of the ratcheting head 22 interior profile 22a; the adjustable socket unit 20 is then secured to the ratcheting housing 22 and within the adjustable socket unit 20 and is secured by a retention pin 22a; the swivel extendable solid arm 24 is attached onto the main ratcheting head yoke 22; the swivel arm 24, has a underside longitudinal channel 24c to control which retains the hollow exterior extending arm 28 to distal selected guided extension, said swivel arm 24 has a substantial right angle hole to house a détente spring induced 24e and spherical ball 24f to retain the hollow extending arm 28 to first retracted position, to the second position and to the third or fully extended position; the ratcheting housing 22 has a right angle pivot hole 22b that mates with the flex arm 24 and is retained by pivot pin 26 which retains the ratchet head sub-assembly 22 with the flexible arm 24, the ratchet head housing 20s aft yoke end has five radially formed dimples 22c that are equally spaced 180 degrees for selecting and retaining the flexible attached arm to a particular pivot angle required for a particular job, the aft yoke of the ratcheting head 20s yoke connects with the lug on the flexible handle 24 with a right angle assembly dowel pin 26, said flex handle 24 has an internal hole 24a to retain a spring loaded détente steel ball bearing 24d to fall into any of the five selected radial dimples 22c of the ratcheting head yoke 22, said flex handle 24 has an underside longitudinal slotted channel 24c to guide pin 28c connected to the outer shell 28.

### SCOPE OF THE INVENTION

The above represents the best descriptive mode contemplated in carrying out this invention, the manner and process of its manufacture, its utilization in such full, clear and concise terms as to enable any person skilled in the art to which it pertains to effectively produce and use this invention. This invention is, however, susceptible to modifications and alternate constructions thereof from that discussed above which are fully equivalent. Consequently, it is not the intention to limit this invention to the particular embodiment disclosed. On the contrary, the intent is to cover all modifications and alternate constructions coming within the spirit and scope of the invention as generally expressed by the following claims, which particularly point out and distinctly claim the subject matter of this invention.

1. A three jaw adjustable socket ratchet wrench with a number of adjustable socket size openings to accommodate different size hexagonal fasteners, a fixed and a lower drive member The upper jaws cylindrical housing retains the three trilateral jaw members that that are positioned 120 degree triangularly and move axially and on a 15 degree taper upwards to a smaller hexagonal size as the three jaws come together. When the user rotates the serrated gear in the opposite rotation of the serrated exposed wheel, the three jaw members' axial movement is expanded downward at 15 degree to a larger hex opening on the Z axis plane and is influenced by a horizontal cylindrical threaded disc that is threaded onto a vertical main threaded helix screw. The threaded disc is nestled within the lower jaws pocket, and the threaded disc driver unit is manually rotatable to a clockwise or counterclockwise rotation depending on the desired jaw openings.

2. The devise in claim 1 having jaw members with an exterior 30 degree included dovetail slot on the jaws back surface. This dovetail feature rides and interlocks within the corresponding male dovetail node feature on the upper cylindrical jaw housing for additional jaw stability and torque strength to each of the three jaw members. The main actuator serrated wheel with the affixed main vertical threaded right hand screw is permanently attached onto the main adjusting exterior knurled thumb wheel located at the ratcheting heads exterior bottom; it is retained internally by a retention dowel pin; a smaller horizontal actuator wheel ring is threaded onto the main vertical screw which is nestled and activates the three jaw members at their lower notch; the manual rotational activation influences the three jaw members to move inward or downward at a 15 degree angled taper; the upper and lower main components are threaded and secured by three horizontal fastener dowel pins.

3. The devise in claim 2 further includes a three jaw adjustable socket ratcheting driver comprising a solid flexible handle having a ratchet head at a distal end thereof; said solid handle having a slide-able hollowed exterior handle means being adjustable between first, second position; a ratcheting pawl mounted within said ratchet head to ratchet a serrated rotate-able gear mounted within said ratcheting head, the ratcheting gear further includes a square cavity to accept a square mating shaft at first end substantially at right angle to said ratcheting gear; the ratcheting gear further includes an extended cylindrical configured shank adapted to house a square second output shaft at 180 degrees thereof; a first output square shaft secured at a first end of said ratchet gear seated within said ratcheting head, said first output square shaft being sized to be received by a first socket adaptive to drive a hex configured fastener of a first size range; and, a second output square shaft secured to said extended cylindrical shank of said ratcheting gear housed within said ratcheting head; said second output shaft being adaptive to drive a socket being adaptive to fit and drive a hex head fastener of a second size range, said second square output shaft being positioned substantially at right angle from the Y axis plane of said solid handle at a distal end of said ratchet head thereof; wherein said ratchet driver is in a second mode of operation, said second square shaft being positioned substantially at right angle from said Y axis plane of said ratchet head when said ratchet driver is in a second mode of operation.

4. The driver of claim 3 further includes an exterior slideable handle that adjusts to said first retracted position to the second mid extension to the third full extension.

5. The driver in claim 4 further includes a handle that adjusts to first 180 degrees position to second +45 degrees position to +90 degrees to −45 degrees position to −90 degrees position.

6. The device in claim 5 further includes a slotted channel extending longitudinally on the underside of said solid arm at a distal end thereof from said ratcheting head to retain said hollowed exterior handle at said first, second and third extended positions.

7. The device in claim 6. where the extending cylindrical shank is at a diametric distance from said ratcheting gear within said ratcheting head thus comprising: a second horizontal square slot to house said second output square shaft that swivels to a folding position and extending vertically to substantially at right angle for second ratcheting mode, said second horizontal square slot to retain said second output square driver shaft within the confines of said square slot of said cylindrical shank of said rotate-able ratcheting gear being housed within said ratcheting head in the second mode; said second square output shaft further includes a horizontal pivoting hole to accept a horizontal retaining pin to retain said second output square shaft to said extended cylindrical configured shank extended from said ratcheting head; said cylindrical shank further includes a knurled exterior for gripping to either fast forward and or reverse ratchet rotation for hand start installation and or hand speed removal of fasteners for said first and second square output shafts of the first and second ratcheting mode.

8. The device in claim 7 wherein said exterior handle length is secured in said first, second hole positions formed on top of said sub-tubular handle being position by said spring induced detent ball housed within said vertical hole positioned in solid flexible ratcheting arm at a distal end of said ratchet head, said detent ball being positioned in said first, second and or third hole formed on said exterior handle.

9. The device in claim 8 wherein a ratcheting driver head comprising: an extending lug at a distal end from said ratcheting driver head having a horizontal pivoting hole to attach a swivel yoke at a distal inner end of said solid ratcheting arm; both being secured by a horizontal retention pin on a distal end of said solid handle being attached to said radius lug end and co-centrally located at a distal end of said ratcheting head; said extending lug further includes spherical radiuses formed around said radius end with said spherical holes radially formed at +30 degrees, to 0 degrees horizontal to the axis, and −30 degrees manual adjustments; said solid handle and said slide-able exterior hollowed handle both pivot from a substantially right angle to the X axis of said square drivers shafts; said pivotal yoke further includes said pivotal pin to retain said solid arm onto said pivotal yoke; said pivotal yoke further includes a spring induced detent ball to seat into three radially spaced and equally spaced said spherical holes formed on said radiuses end of said lug from said ratcheting head, as said solid arm is being manually adjusted upwards to said +45 degrees angle, said spring induced detent ball on said yoke on said solid arm seats, and locks said solid arms dimple at said −45 degrees downwards angle, as said solid arm is readjusted back to said central Y axis dimple on said yoke end of said solid arm is thus locked in that position, and when said solid arm is readjusted downwards to said +90 degrees right angle, said detent ball secures said solid arm in said third position from said 180 degrees from said substantial −90 right angle of said axis.
